(19) United States
(12) Patent Application Publication
(10) Pub. No.: US 2011/0050179 A1
(43) Pub. Date: Mar. 3, 2011

(54) IDLE STOP CONTROL DEVICE AND IDLE STOP CONTROL METHOD

(75) Inventors: Tateki MITANI, Chiyoda-ku (JP); Shigeki KONDO, Chiyoda-ku (JP); Satoshi NISHIKAWA, Chiyoda-ku (JP); Shingo IWAI, Oda-gun (JP)

(73) Assignee: Mitsubishi Electric Corporation, Tokyo (JP)

(21) Appl. No.: 12/687,602

(22) Filed: Jan. 14, 2010

(30) Foreign Application Priority Data
Sep. 3, 2009 (JP) 2009-203730

(51) Int. Cl. H02J 7/04; G01N 27/416; H02J 7/00

(52) U.S. Cl. 320/150; 324/432; 320/137; 180/65.29

(57) ABSTRACT

An idle stop control device for determining on the basis of a charging state of a battery whether idle stop should be executed or not includes, as a unit for detecting the charge state of the battery, an optical fiber type battery solution concentration sensor including an optical fiber which is partially immersed in battery solution to measure the refractive index of the battery solution, thereby measuring the concentration of the battery solution.

### BACKGROUND OF THE INVENTION

1. Field of the Invention

The present invention relates to an idle stop control device and an idle stop control method for optimally determining in accordance with a charging state of a battery whether idle stop is possible or not.

2. Description of the Related Art

When idle stop is executed under the state that a charging state of a battery is not sufficient, it takes much time to restart an engine or it may be impossible to restart the engine in some cases. Therefore, it is determined on the basis of the charging state of the battery whether idle stop is executed or not. Idle stop control devices of indirectly measuring the charging state of the battery have been hitherto known. For example, there are known a control device of detecting a terminal voltage of a battery and determining on the basis of the detection result whether the engine can be cranked or not after the engine is stopped (see JP-A-2002-174133, for example) and a control device of time-integrating charging/discharging current of the battery to calculate the charging amount of the battery (see JP-A-2001-224103, for example).

Furthermore, the concentration of electrolytic solution in a battery has close relationship with the state of the battery, and the residual capacity of the battery can be measured by measuring the electrolytic solution concentration. Therefore, the electrolytic solution concentration can be known by measuring variation of the refractive index of the electrolytic solution, and in view of this point, the variation of the refractive index is measured by using optical parts such as a light emitting element, a photodetecting element, a prism, etc. as a sensor, thereby directly measuring the charging state of the battery (see JP-B-58-22867, for example).

In devices for indirectly measuring the charging state of the battery as disclosed in JP-A-2002-174133 and JP-A-2001-224103, a voltage sensor or a current sensor must be used, and further the charging amount is assumed by using a temperature sensor as a parameter. Therefore, it is concerned that the measurement precision is deteriorated in accordance with an environmental condition. Furthermore, devices of directly measuring the charging state of the battery as disclosed in JP-B-58-22867 have a problem that the precision is lowered due to soil of the surfaces of optical parts such as the prism, etc.

### SUMMARY OF THE INVENTION

The present invention has been implemented in view of the foregoing problem, and has an object to provide an idle stop control device that can measure the charging state of a battery with high precision and easily apply a measurement result to a determination as to whether it is possible to execute idle stop or not.

In order to attain the above object, according to an aspect of the present invention, an idle stop control device for determining on the basis of a charging state of a battery whether idle stop should be executed or not contains, as a unit for detecting the charge state of the battery, an optical fiber type battery solution concentration sensor including an optical fiber which is partially immersed in battery solution to measure the refractive index of the battery solution, thereby measuring the concentration of the battery solution.

Furthermore, according to another aspect of the present invention, an idle stop control method includes; detecting on the basis of signals from various kinds of sensors whether a vehicle is under an idle state; measuring the refractive index of battery solution by a battery solution concentration sensor; calculating the charging rate of the battery on the basis of a signal representing the refractive index of the battery solution; measuring the temperature of the battery solution by a battery solution temperature sensor; and determining on the basis of the battery charging rate calculating step and the battery solution temperature measuring step whether an idle stop condition is satisfied.

According to the idle stop control device and method of this invention, the refractive index of the battery solution is measured by using the optical fiber type battery solution concentration sensor, and the charging state of the battery state can be directly checked by using the temperature as a parameter. Therefore, it is unnecessary to provide a current sensor or a voltage sensor, and also an optical fiber element having a very small surface area is merely inserted into battery solution. Therefore, the battery solution is hardly polluted with soil, and also the measurement precision is not deteriorated in accordance with an environmental condition. Furthermore, the charging/discharging state of the battery can be directly measured on a real-time basis, and thus the idle stop control can be executed stably with high precision. In addition, the deterioration status of the battery can be grasped. Therefore, comprehensively excellent idle stop control which also serves to inform deterioration can be performed.

The foregoing and other object, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing the basic construction of an idle stop control device;

FIG. 2 is a conceptual diagram showing the construction of an optical fiber type battery solution concentration sensor according to a first embodiment of the present invention

FIG. 3 shows actually measured data representing the relationship between the battery solution concentration and the output (refractive index) of the optical fiber type battery solution concentration sensor according to the present invention;

FIG. 4 is a diagram showing a switching state of the idle stop according to this invention;

FIG. 5 is a flowchart showing the flow of the idle stop control;

FIG. 6 is a conceptual diagram showing the construction of an optical fiber type battery solution concentration according to a second embodiment of the present invention; and

FIG. 7 is a characteristic diagram showing a method of determining deterioration of battery solution in the battery.

### PREFERRED EMBODIMENTS OF THE INVENTION

Preferred embodiments according to the present invention will be described hereunder with reference to the accompanying drawings.

### First Embodiment

A first embodiment of an idle stop control device according to the present invention will be described with reference to the accompanying drawings.

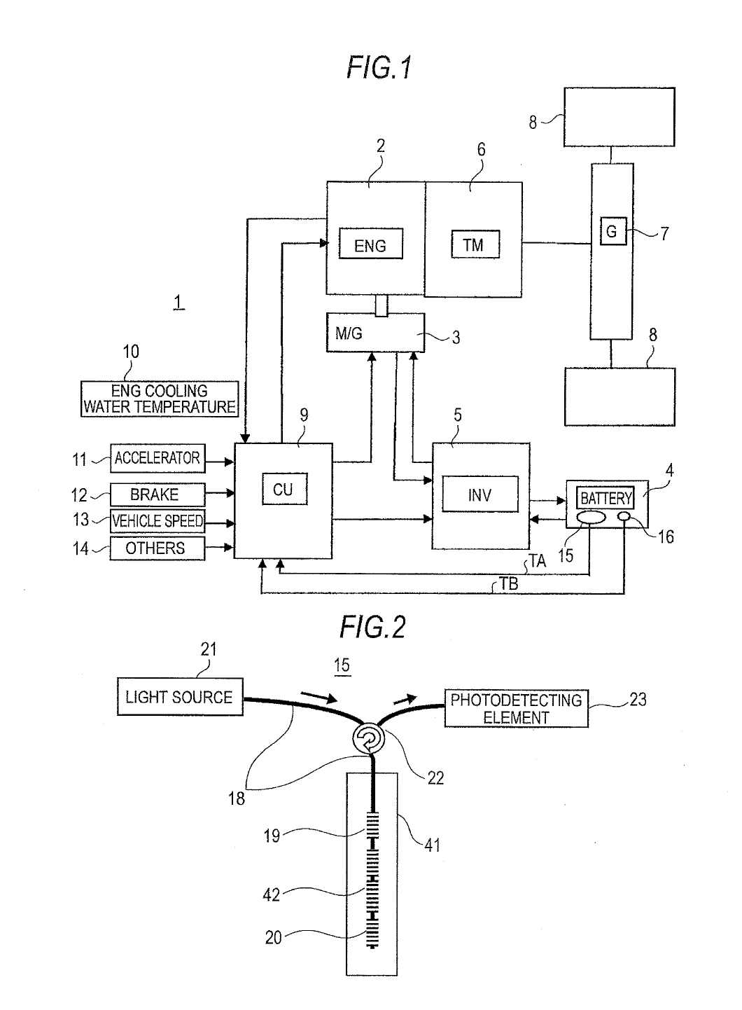

FIG. 1 is a diagram showing the basic construction of an idle stop control device 1. In FIG. 1, reference numeral 2 represents an engine as a driving source, and reference numeral 3 represents an electric motor generator which serves as an electric motor to drive the engine 2 at the start-up time or the like and also serves as an electric generator to charge a battery 4 after the engine 2 is driven. Reference numeral 5 represents an inverter which is inserted between the battery 4 and the electric motor generator 3, rectifies generated power from the electric motor generator 3 to charge the battery 4 and conversely supplies current from the battery 4 to the electric motor generator 3, and the inverter performs mutual conversion between AC and DC.

Reference numeral 6 represents a transmission for transmitting the power of the engine 2 to rear wheels 8 through a gear 7 while shifting gears. Reference numeral 9 represents a control unit for receiving input signals from various kinds of sensors 10 to 16 and outputting an instruction concerning idle stop, and it is constructed by CPU, RAM, ROM, etc. Reference numeral 10 represents an engine cooling water temperature (T_{E}) sensor, reference numeral 11 represents an acceleration sensor, reference numeral 12 represents a brake sensor, reference numeral 13 represents a vehicle speed sensor, reference numeral 14 represents other sensors, and reference numeral 15 represents a battery solution concentration sensor indicating the charging state of the battery. T_{A} represents the output signal thereof. Reference numeral 16 represents a battery solution temperature sensor, and T_{B} represents the output signal thereof. These output signals are input to the control unit 9.

FIG. 2 is a conceptual diagram showing the construction of the optical fiber type battery solution concentration sensor 15 of this invention, and shows a state that the optical fiber is inserted into the battery solution. In FIG. 2, reference numeral 41 represents a part of the battery shape, and reference numeral 42 represents the battery solution. Reference numeral 18 represents an optical fiber which will be described in detail later, and one end side of the optical fiber is immersed in the battery solution 42. In the optical fiber 18 immersed in the battery solution 42, reference numeral 19 represents a fiber grating portion constructed by forming a grating on a core, and reference numeral 20 represents a reflecting fiber grating portion for reflecting light led to the fiber grating portion 19 from the end face thereof.

Reference numeral 21 represents a light source comprising LED, for example, reference numeral 22 represents a circulator for leading light emitted from the light source 21 to the fiber grating portion 19 of the optical fiber 18, and reference numeral 23 represents a photodetecting element for detecting total intensity of light which is reflected from the reflecting fiber grating portion, passed through the circulator 22 and then incident to the photodetecting element 23. The battery solution concentration sensor 15 is an optical fiber type refractive index sensor for detecting variation of transmitted light amount of the fiber grating portion 19 by utilizing the fact that the clad mode spectrum of the fiber grating portion 19 varies in accordance with the liquid refractive index around the clad (see WO2006/126468A1), and this sensor is known as being capable of implementing high-precision refractive index measurement.

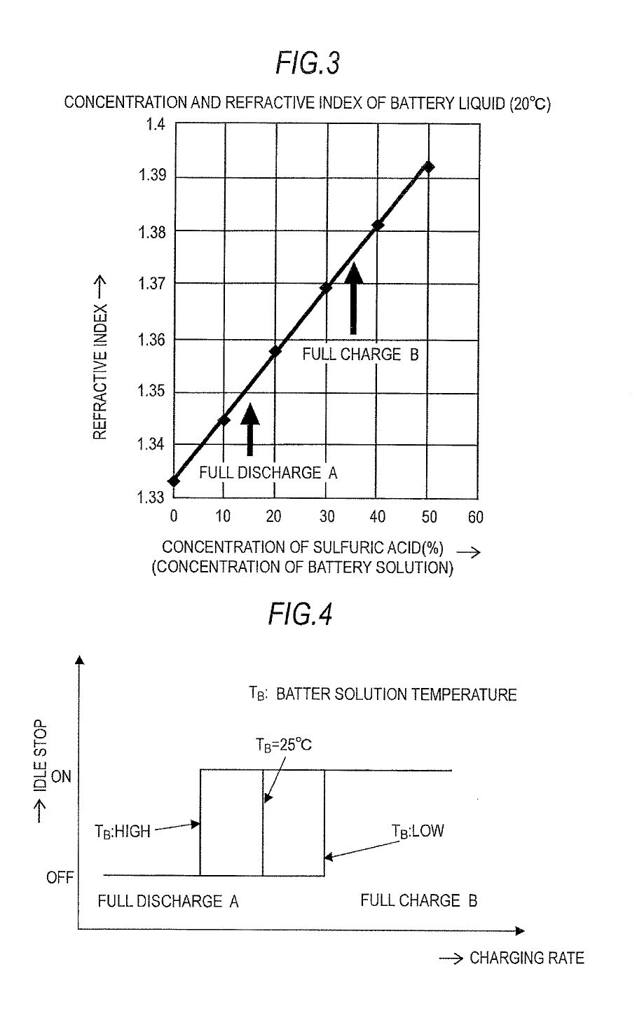

FIG. 3 shows actual measurement values showing the relationship between the refractive index (ordinate axis) as the output of the battery solution concentration sensor 15 described above and the battery solution concentration (abscissa axis). In FIG. 3, an arrow A represents a value when the battery is perfectly discharged, and an arrow B represents a value when the battery is fully charged. The linearity between the perfect discharge state and the full charge state is very excellent. Accordingly, if the refractive index as the output of the battery solution concentration sensor is known, the battery solution concentration (sulfuric acid concentration %), and thus the charting state of the battery becomes apparent. The actual measurement value data are stored in ROM of the control unit 9 in advance, and used to be compared with the measurement result of the refractive index and immediately calculate the battery solution concentration.

FIG. 4 is a diagram showing the switching state of the idle stop. The charging rate of the battery is plotted on the abscissa axis, and whether the switching state is shifted to idle stop (ON) or is not shifted to idle stop (OFF) is represented by using the battery solution temperature (T_{B}) as a parameter. That is, it is apparent from FIG. 4 that the switching state can be shifted to the idle stop in the case of high T_{B} even when the charging rate is low, however, the switching state cannot be shifted to the idle stop in the case of low T_{B} unless the charging rate is high. These data are stored in ROM of the control unit 9 in advance, and used to determined whether the idle stop condition is satisfied as described later.

Next, the actual operation will be described. The optical fiber 18 having the fiber grating portion 19 is inserted into the battery 4 shown in FIG. 1. As described above, light from the light source 21 passes through the circulator 22 and enters the optical fiber 18, and the principle that the clad mode spectrum at the fiber grating portion 19 varies in accordance with the refractive index of the battery solution surrounding the clad is utilized. Accordingly, the refractive index can be known by measuring the variation of the clad mode spectrum at the fiber grating portion 19. Accordingly, the charging state of the battery which has primary linear relationship with the refractive index can be measured as described above. Quartz glass which is improved in acidic resistance and contains a high content of zirconium is used as the optical fiber 18 being used to thereby enhance reliability.

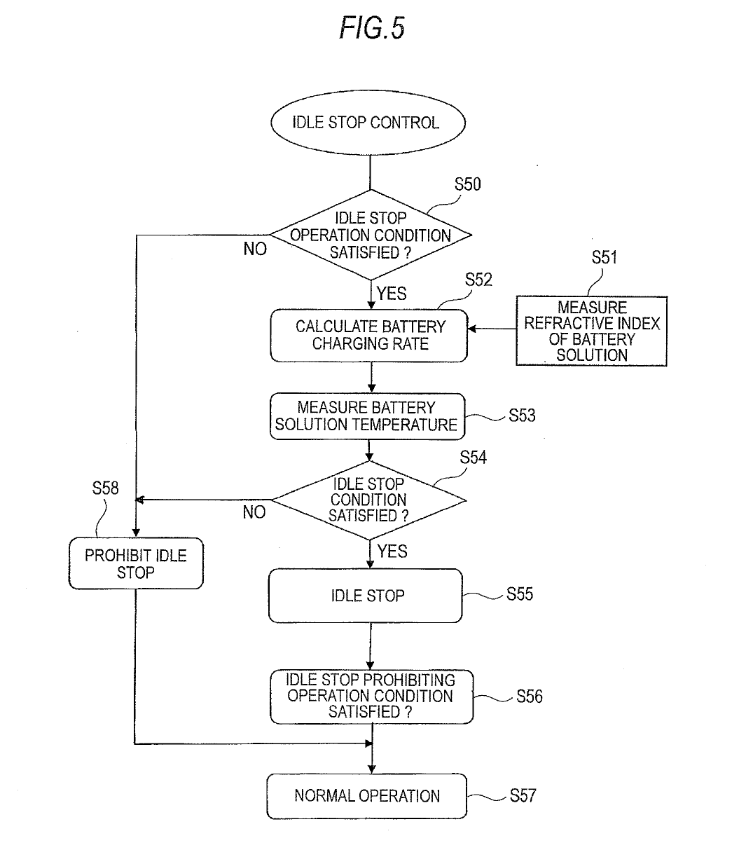

Next, the idle stop function will be described with reference to FIG. 5. FIG. 5 is a flowchart showing the flow of the idle stop control, and it is first determined in step 50 whether the output signals from the various kinds of sensors to the control unit 9 of FIG. 1 satisfy an idle stop operation condition.

The idle stop operation condition (step 50) contains a condition that the engine cooling water temperature sensor 10 indicates a predetermined temperature or more, the acceleration sensor 11 indicates the state that the accelerator is not depressed, the brake sensor 12 indicates the state that the brake is depressed, the vehicle speed sensor 13 indicates no detection state (stop state), or the like, and detects that there is a vehicle under the idle state such as a stoplight waiting state or the like.

The refractive index of the battery solution is measured by the battery solution concentration sensor 15 (step 51), and the charging rate of the battery is calculated on the basis of this signal (T_{A}) (step 52). Furthermore, the battery solution temperature is measured by the battery solution temperature sensor 16 (step 53), and a signal (T_{B}) is output. At this time, if the state of the battery or the battery temperature is neglected, when power is supplied from the battery 4 through the inverter 5 to the electric motor generator 3 to make the electric motor generator 3 function as an electric motor and start up the engine after the vehicle is set to the idle stop, it would take much time to start up the engine or it would be impossible to start up the engine in the worst case.

Accordingly, in this invention, it is determined from the battery charging rate calculating step 52 and the battery solution temperature measuring step 53 whether the idle stop condition is satisfied or not (step 54). That is, the data of FIG. 4 representing the switching state of the idle stop described above are read out by the control unit 9. When T_{B} is high, the vehicle can be shifted to the idle stop in spite of the low charging rate (step 55). However, when T_{B} is low, the vehicle cannot be shifted to the idle stop unless the charging rate is high (step 58).

If the condition gets out of the idle stop operation condition (step 50) or the condition based on the battery charging rate calculating step 52 and further the condition based on the battery solution temperature measuring step 53, an idle stop prohibiting operation condition (step 56) is satisfied, and thus the processing returns to a normal operation step 57. When the idle stop prohibiting operation condition step 58 is satisfied in any stage, the processing returns to the normal operation 57.

As described above, according to this invention, the charging and discharging states of the battery solution can be directly calculated, and the temperature state of the battery is set as a parameter, whereby the idle stop function can be safely and surely performed at low price.

### Second Embodiment

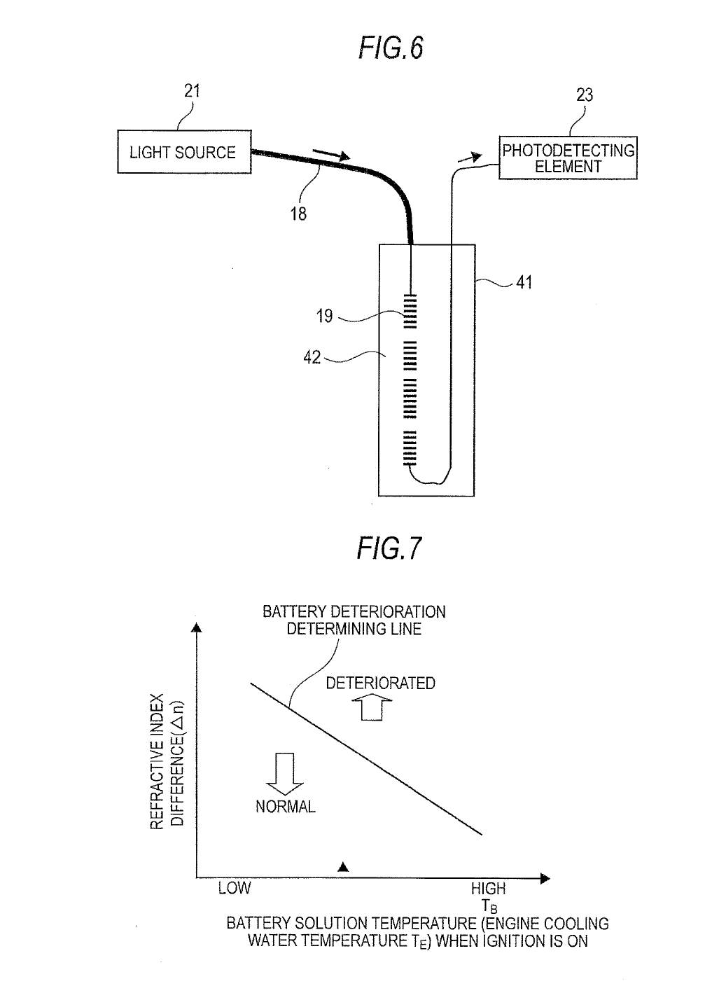

As shown in FIG. 6, a second embodiment is configured so that the circulator 22 in the first embodiment is not used, the reflecting fiber grating 20 for reflecting light from the end face of the optical fiber 18 is not provided, and one end of the optical fiber 18 is bent at a predetermined curvature radius or more to directly return light to the photodetecting element 23. By even the construction described above, the same effect as the first embodiment can be obtained.

### Third Embodiment

FIG. 7 is a characteristic diagram showing a method of determining deterioration of the battery solution 42 in the battery 4 as an additional function, and the charging capability of the battery 4 is deteriorated when it is used for a long term. When an ignition switch (not shown) is turned on, a value (refractive index) when the ignition switch was previously turned off is stored. Deterioration or Normality is determined on the basis of the difference An between the refractive index values and the signal (T_{B} of the battery solution temperature sensor 16 when the ignition switch is turned on. That is, when the value of T_{B} is high, the recovery power of the battery 4 is originally high, and thus deterioration is determined even when the refractive index difference An is small. On the other hand, when the value of T_{B} is low, the recovery power of the battery 4 is low, and thus the determination criterion of deterioration is high even when the refractive index difference Δn is large.

In the foregoing description, the method of controlling the idle stop by using the battery solution concentration and the battery solution temperature has been described. If the correlation between the battery solution temperature and the engine cooling water temperature is established, the engine cooling water temperature can be used in place of the battery solution temperature, and thus it is unnecessary to measure the battery solution temperature. It is needless to say that both the battery solution temperature and the engine cooling water temperature can be used to further enhance the control precision.

Furthermore, when the battery solution concentration sensor is disconnected or short-circuited, the output voltage of the battery solution concentration sensor may be set to a high value or low value which would be impossible in a normal state, whereby it acts to the safe side so that the vehicle is prevented from entering the idle stop, and the system having high reliability can be likewise supplied.

The battery solution concentration sensor may be used in combination with a display function of informing a driver of the charging rate of the battery, whereby the practical effect can be further enhanced.

Various modifications and alterations of this invention will be apparent to those skilled in the art without departing from the scope and spirit of this invention, and it should be understood that this is not limited to the illustrative embodiments set forth herein.

What is claimed is:

1. An idle stop control device for determining on the basis of a charging state of a battery whether idle stop should be executed or not, comprising, as a unit for detecting the charge state of the battery, an optical fiber type battery solution concentration sensor including an optical fiber which is partially immersed in battery solution to measure the refractive index of the battery solution, thereby measuring the concentration of the battery solution.

2. The idle stop control device according to claim 1, wherein the optical fiber has a core having a grating formed thereon and a clad, a light source for making light incident into the optical fiber, and a photodetecting element for detecting the total intensity of light which is incident from the light source into the optical fiber and passed through the grating.

3. The idle stop control device according to claim 2, wherein the optical fiber type battery solution concentration sensor has a reflecting fiber grating on an end face of the optical fiber in the battery, and a circulator at some midpoint of the passage of the optical fiber.

4. The idle stop control device according to claim 2, wherein the optical fiber type battery solution concentration sensor is configured so that an end face of the optical fiber in the battery is bent at a curvature radius of a fixed value or more and light passing through the grating is directly incident to the photodetector without passing through any circulator.

5. The idle stop control device according to claim 1, further comprising a battery solution temperature sensor, wherein an idle stop switching mode is set so that when an output T_{B} of the battery solution temperature sensor is high, a vehicle can be shifted to the idle stop in spite of low charging rate, and when the output T_{B} is low, the vehicle cannot be shifted to the idle stop unless the charging rate is high.

6. The idle stop control device according to claim 1, wherein the optical fiber is subjected to an acidic-resistance treatment.

7. An idle stop control method comprising:
detecting on the basis of signals from various kinds of sensors whether a vehicle is under an idle state;
measuring the refractive index of battery solution by a battery solution concentration sensor;
calculating the charging rate of the battery on the basis of a signal representing the refractive index of the battery solution;
measuring the temperature of the battery solution by a battery solution temperature sensor; and
determining on the basis of the battery charging rate calculating step and the battery solution temperature measuring step whether an idle stop condition is satisfied.

8. The idle stop control method according to claim 7, wherein an idle stop switching mode is set so that when an output T_{B} of a battery solution temperature sensor is high, a vehicle can be shifted to the idle stop in spite of low charging rate, and when the output T_{B} is low, the vehicle cannot be shifted to the idle stop unless the charging rate is high.

9. The idle stop control method according to claim 7, wherein a deterioration degree of the battery is determined by comparing a difference value An between a value of the battery solution concentration sensor under an ignition-off state and a value of the battery solution concentration sensor under an ignition-on state with a value of the battery solution concentration sensor under the ignition-on state.

10. The idle stop control method according to claim 9, wherein when the deterioration degree of the battery is determined, a value of an engine cooling temperature relating to a battery solution temperature is used.
